(19) United States
(12) Patent Application Publication
(10) Pub. No.: US 2013/0270335 A1
(43) Pub. Date: Oct. 17, 2013

(54) FRENCH FRY CONE

(71) Applicants: Luc Segers, Brussels (BE); Antonio Malandrini, Fontaine-l'Eveque (BE); Louis Derwa, Waterloo (BE)

(72) Inventors: Luc Segers, Brussels (BE); Antonio Malandrini, Fontaine-l'Eveque (BE); Louis Derwa, Waterloo (BE)

(21) Appl. No.: 13/823,155

(22) PCT Filed: Sep. 14, 2011
(86) PCT No.: PCT/EP2011/065904

§ 371 Date: May 21, 2013

(30) Foreign Application Priority Data
Sep. 14, 2010 (BE) 2010/0542

(51) Int. Cl. B65D 5/42; B31B 1/62; B65D 5/48

(52) U.S. Cl. CPC B65D 5/4295; B65D 5/48002; B31B 1/62
USPC 229/400; 493/128

(57) ABSTRACT

This invention generally relates to a cone for chips. Unlike other cardboard cones for chips, the model presented here includes, at the base of the cone, a small opening as well as a series of small holes in the middle of the four faces. These various openings let the air circulate, thereby preventing the formation of steam produced by the heat of the chips, keep the chips really crispy and mean that the cone stays rigid throughout its use.

In another production mode, the cone has a compartment located at the inner tip of the cone and integrated into it, which can be folded to hold sauce.

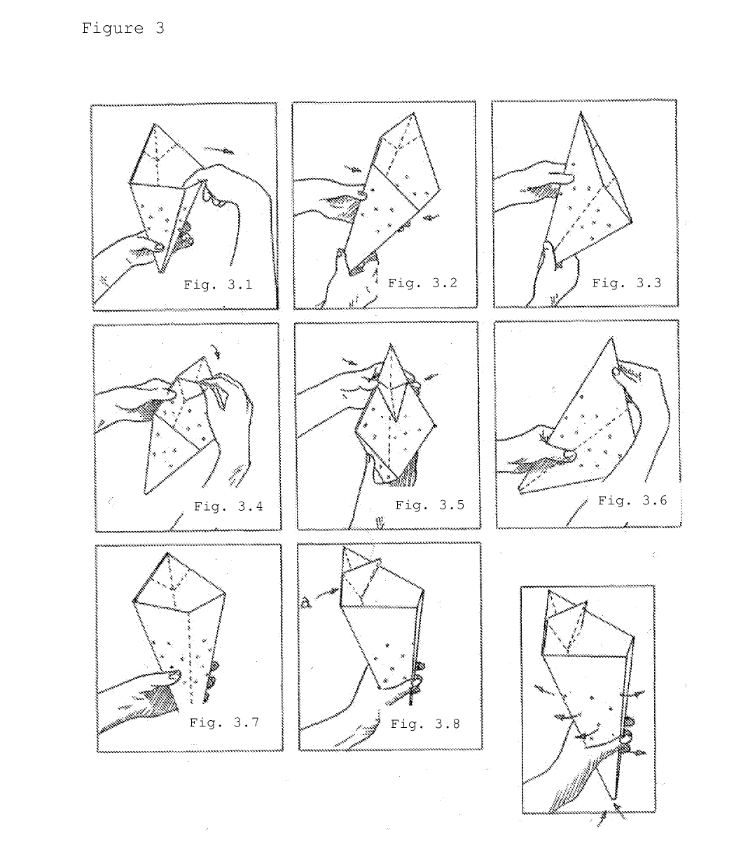

Unlike other cardboard cones for chips, the model presented here includes, at the base of the cone, a small opening as well as a series of small holes in the middle of the four faces. These various openings let the air circulate, thereby preventing the formation of steam produced by the heat of the chips, keep the chips really crispy and mean that the cone stays rigid throughout its use. The cone's constant rigidity and the impermeability of the type of paper (single face) used mean that the user's hands stay clean. A compartment inside the top of the cone and integrated into it can be folded in said way that it becomes a container for sauce (FIG. 3, FIGS. 3.4 to 3.8). This sauce compartment allows the user to keep a hand free, avoid having sauce on their hand when taking chips out of the cone and make sure that there is enough sauce, even for the last chip. This sauce compartment, therefore, avoids the need to use another plastic receptacle, which usually holds the sauce that accompanies the chips, thereby saving money: no procurement or taxation on plastic sauce receptacles. There is a further, ecological, benefit, with less pollutant waste.

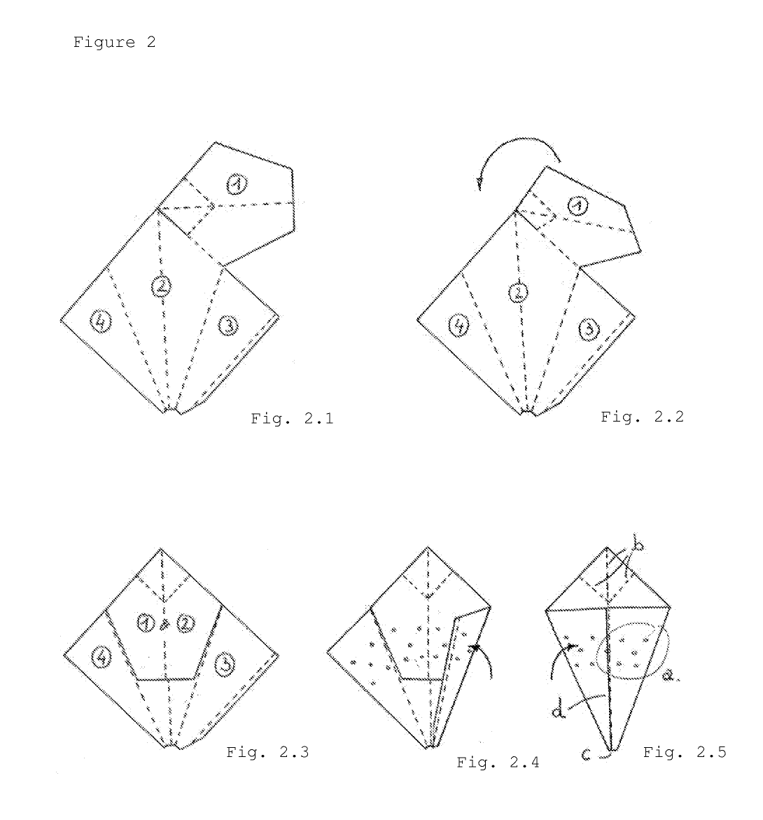

The “single face” paper used is, preferably, an ecological layered paper or cardboard with the FCS Mixed sources label, the surface of which is covered with a layer placed on one of the two faces and known as a “single face” type paper. The chip cone is made from “single face” type paper. The outer surfaces are glossy (smooth surface); the inner surface is matt, so that it absorbs the chip fat. The outer, glossy face prevents the fat from seeping through the paper. Once closed, the chip cone takes the form of an irregular diamond (FIG. 2 FIG. 2.5), with the large diagonal being vertical. Halfway up the cone is a series of small holes, around 2 mm, between approximately 0.5 and 10 mm and, in particular, around 3, 4, 5, 6, 7, 8 or 9 mm in diameter (FIG. 2 FIG. 2.5, point a). They form a band around 65 mm high, between approximately 30 and 80 mm high and, in particular, between 50 and 70 mm high. In the top corner can be found 3 fold marks for the sauce compartment (FIG. 2 FIG. 2.5, point b). The bottom corner of the diamond is cut at around 10 mm, between approximately 5 and 15 mm (FIG. 2 FIG. 2.5, point c). On the lower two thirds of the large diagonal of the diamond is a line that represents the location of the tab for gluing (FIG. 2 FIG. 2.5, point d).

Open and frontal, the cone represents an inverse, truncated pyramid (FIG. 3). Each of the 4 faces of the cone includes small holes (FIG. 3). In the upper angle of the pyramid, 3 fold marks for the sauce compartment can be found (FIG. 3 FIG. 3.1). When the cone is turned slightly to the right (FIG. 3 FIG. 3.8), on the top left section of the inverse pyramid, a double layer of inner paper can be distinguished (FIG. 3 FIG. 3.8, point a).

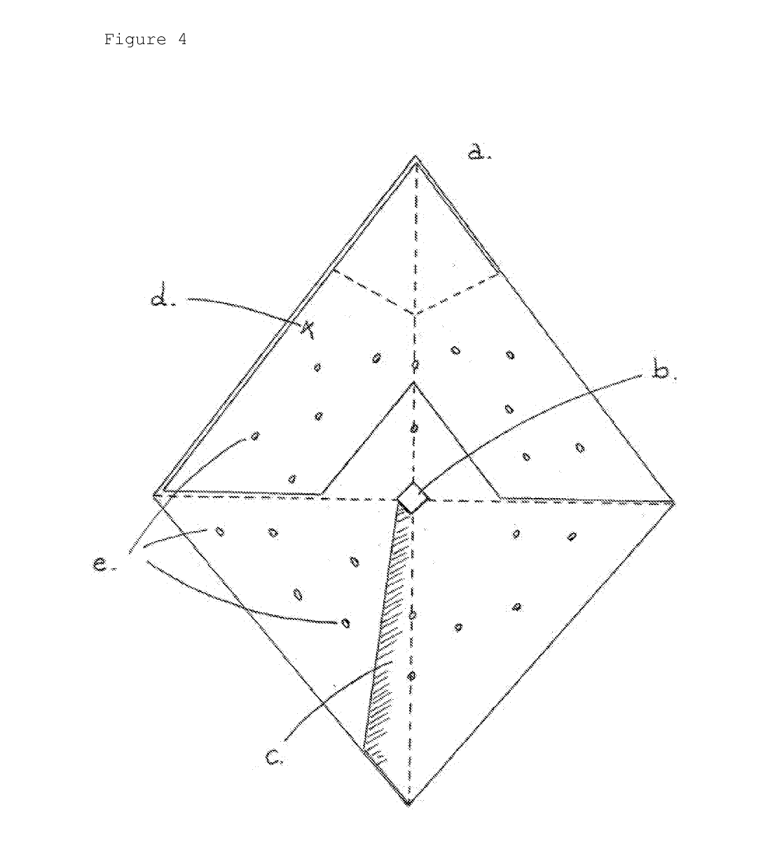

Open and seen from the top, the cone represents a quadrilateral resting on one of its angles. If the top wing is pulled upwards (FIG. 4, point a), a small diamond may be seen in the centre of the shape (FIG. 4, point b). On the left side of the bottom corner is located the tab for gluing that runs from the lower left side to the central diamond (FIG. 4, point c). On the entire upper left side and the upper half of the upper right side can be seen the double layer of paper (FIG. 4, point d). The holes are located at the centre of the shape (FIG. 4, point e).

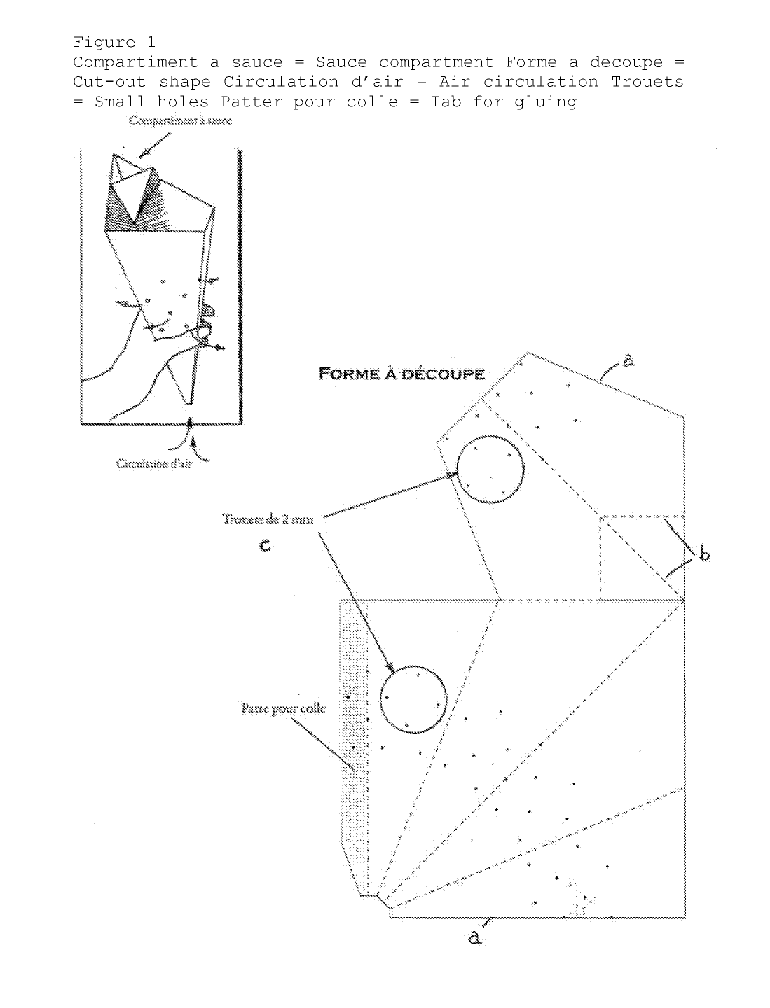

This cone is made up of a single pre-cut piece of paper that is folded and glued. The cut-out shape (FIG. 1) uses cutter lines for cutting (FIG. 1, point a), others for folding (FIG. 1, point b) and small punches to perforate the holes (FIG. 1, point c).

The shaping and the gluing, after cutting (FIG. 2), takes place in 4 stages. In FIG. 2.1 of FIG. 2, the shape is divided into 4 large sections. The first stage involves turning section 1 down onto section 2 along the fold line (FIG. 2, FIG. 2.2). The second stage involves turning section 3 onto sections 1 and 2 along the fold line (FIG. 2, FIG. 2.4). The third stage involves gluing the tab for gluing of section 3 (FIG. 1) and the fourth involves turning section 4 onto the glued section along the fold line (FIG. 2, FIG. 2.5).

1-10. (canceled)

11. A foldable cone comprising a single piece of paper including a base and four faces thereon, said cone comprising aeration holes at said base and on said four faces.

12. The foldable cone of claim 11 wherein said aeration holes are located in the center of said four faces.

13. The foldable cone of claim 11 wherein said holes form a band having a height between about 30 and 80 mm.

14. The foldable cone of claim 11 wherein the diameter of the holes in said four faces is between about 0.5 and 5 mm.

15. The foldable cone of claim 11 wherein said piece of paper comprises a single face paper having an outer surface and an inner surface.

16. The foldable cone of claim 15 wherein said outer surface has a glossy face.

17. The foldable cone of claim 15 wherein said inner surface has a matte face.

18. The foldable cone of claim 11 comprising a foldable compartment which is integral with said cone.

19. A foldable cone blank with an integral sauce compartment comprising a single piece of paper, said blank including a cone portion having a plurality of fold lines adapted for forming said cone portion into an inverted pyramid shape, said cone portion including four faces with fold lines therebetween, each of said faces including a plurality of aeration holes, said cone portion further including a gluing tab extending substantially along the length one of said faces and adapted to be folded and glued to an opposing face to form said cone portion; said integral sauce compartment being connected to said cone portion along a fold line, said sauce compartment including a pair of faces with a fold line therebetween and having aeration holes in each face, said sauce compartment adapted to be folded into the interior of said cone portion.

20. A method of forming a cone for chips having an integral sauce compartment comprising, folding the cone blank of claim 19 by first folding the integral sauce compartment onto the middle two faces of said cone blank, folding the faces of the cone portion onto one another, and securing the edges of the cone portion together by gluing the tab on one edge of a face to an edge of an opposing face on the cone.
